(19) United States
(12) Patent Application Publication
(10) Pub. No.: US 2024/0162410 A1
(43) Pub. Date: May 16, 2024

(54) NON-AQUEOUS ELECTROLYTE SECONDARY BATTERY

(71) Applicant: Panasonic Energy Co., Ltd., Moriguchi-shi, Osaka (JP)

(72) Inventors: Yuki Hayashi, Osaka (JP); Takeshi Chiba, Osaka (JP)

(73) Assignee: Panasonic Energy Co., Ltd., Moriguchi-shi, Osaka (JP)

(21) Appl. No.: 18/281,364

(22) PCT Filed: Mar. 8, 2022
(86) PCT No.: PCT/JP2022/010020

§ 371 Date: Sep. 11, 2023

(30) Foreign Application Priority Data
Mar. 17, 2021 (JP) 2021-043142

(51) Int. Cl. H01M 4/131; H01M 4/02

(52) U.S. Cl. CPC H01M 4/131; H01M 2004/021; H01M 2004/028

(57) ABSTRACT

A non-aqueous electrolyte secondary battery according to one embodiment, wherein a mixture layer of an electrode has a first layer formed on a core body, and second and third layers formed on the first layer. The first, second, and third layers contain a binding agent, and the third layer is formed on at least a part of an end of the electrode. The content of the binding agent in the third layer is higher than the content of the binding agent in the first layer, and is greater than 0.8 mass % and less than 2.0 mass %.

### TECHNICAL FIELD

The present disclosure relates to a non-aqueous electrolyte secondary battery.

### BACKGROUND ART

In recent years, non-aqueous electrolyte secondary batteries such as lithium ion batteries are employed in various applications such as equipment onto a vehicle, storage of electricity, and the like. The required performances of the non-aqueous electrolyte secondary batteries for these purposes include high capacity and superior charge/discharge cycle characteristic. Because an electrode which is a primary constituting element of a battery significantly affects these battery performances, there have been many studies for an electrode structure. For example, Patent Literature 1 discloses a method in which, in order to achieve high capacity by preventing a missing part of a mixture layer during manufacturing of the electrode, a binder solution is applied along a cutting pattern so that a concentration of the binder in a positive electrode mixture in a cutting site which becomes an end portion of the electrode is higher relative to a concentration of the binder in the positive electrode mixture at non-cutting sites.

### CITATION LIST

### Patent Literature

PATENT LITERATURE 1: JP 2006-54115 A

### SUMMARY

### Problem to be Solved

According to the method of Patent Literature 1, it is possible to suppress the missing part of the mixture layer during manufacturing of the electrode. However, it was found that, when an electrode assembly is formed using the electrode of Patent Literature 1, it becomes more difficult for the electrolyte solution, squeezed out from an inside of the electrode assembly due to expansion of the electrode assembly due to charging and discharging, to return to the inside of the electrode assembly, resulting in non-uniformity of the electrode reaction, and, consequently, a greater degree of reduction of the capacity due to the charging and discharging. In this case, it can be deduced that a portion of high concentration of the binder is formed at the end portion of the electrode, blocking the return of the electrolyte solution.

An advantage of the present disclosure lies in provision of a non-aqueous electrolyte secondary battery in which the missing part of the electrode mixture layer can be suppressed and which has a superior cycle characteristic.

### Solution to Problem

According to one aspect of the present disclosure, there is provided a non-aqueous electrolyte secondary battery including: an electrode having a core and a mixture layer formed over the core; and a non-aqueous electrolyte, wherein the mixture layer includes a first layer formed over the core, and a second layer and a third layer formed over the first layer, each of the first layer, the second layer, and the third layer includes a binder, the third layer is formed over at least a part of an end portion of the electrode, a content of the binder in the third layer is higher than a content of the binder in the first layer, and is greater than 0.8 mass % and lower than 2.0 mass %, and a content of the binder in the second layer is lower than or equal to the content of the binder in the first layer.

### Advantageous Effects

According to a non-aqueous electrolyte secondary battery of an aspect of the present disclosure, superior cycle characteristic can be realized while suppressing the mixing part of the electrode mixture layer.

### BRIEF DESCRIPTION OF DRAWINGS

FIG. 1 is a cross-sectional diagram of a non-aqueous electrolyte secondary battery according to an embodiment of the present disclosure.

FIG. 2 is a plan view of a positive electrode according to an embodiment of the present disclosure.

FIG. 3 is a cross-sectional diagram along a line AA of FIG. 2.

### DESCRIPTION OF EMBODIMENTS

When a missing part occurs in the electrode mixture layer, the missing part not only causes reduction of the capacity, but also, the missed mixture layer may become a foreign object, causing minute short-circuiting. As such, prevention of the missing part of the mixture layer is an important issue. The missing part of the mixture layer tends to occur at an end portion of the electrode, particularly during a cutting process in the manufacturing of the electrode. Thus, a method has been proposed to prevent the missing part by increasing an amount of a binder in the mixture layer at the end portion of the electrode. However, when the amount of binder in the mixture layer is simply increased, as described above, the return of the electrolyte solution to the inside of the electrode assembly is blocked, resulting in non-uniform electrode reaction and an increased degree of reduction of the capacity due to the charging and discharging.

The present inventors have eagerly studied to solve the above-described problem, and found that, by employing a layered structure for the electrode mixture layer including a first layer formed over a core, and a second layer and a third layer formed over the first layer, and forming the third layer having a higher content of a binder than the first layer over at least a part of an end portion of the electrode, the cycle characteristic can be improved while suppressing the missing part of the mixture layer. In this case, the third layer having a larger amount of the binder suppresses the missing part of the mixture layer at a high level. In addition, because the first layer having a smaller amount of the binder is present below the third layer at the end portion of the electrode, the electrolyte solution can permeate via the first layer, making it easier for the electrolyte solution squeezed out from the inside of the electrode assembly to return. Thus, the suppression of the missing part of the mixture layer and the improvement of the cycle characteristic can both be realized.

In particular, by setting a content of the binder in the second layer to be lower than the content of the binder in the first layer, the permeability of the electrolyte solution to the inside of the mixture layer can be further improved, resulting in a more significant improvement effect of the cycle characteristic.

A non-aqueous electrolyte secondary battery according to an embodiment of the present disclosure will now be described in detail with reference to the drawings. A selective combination of a plurality of embodiments and alternative configurations described below is included in the present disclosure.

In the following, a circular cylindrical battery will be exemplified in which an electrode assembly 14 of a wound type is housed in an outer housing can 16 of a circular cylindrical shape with a bottom, but the outer housing of the battery is not limited to the outer housing can of the circular cylindrical shape, and may alternatively be, for example, an outer housing can of a polygonal shape (polygonal battery), or an outer housing can of a coin shape (coin battery), or may be an outer housing formed from laminated sheets including a metal layer and a resin layer (pouch type battery). In addition, the electrode assembly may alternatively be an electrode assembly of a layered type, in which a plurality of positive electrodes and a plurality of negative electrodes are alternately layered with separators therebetween.

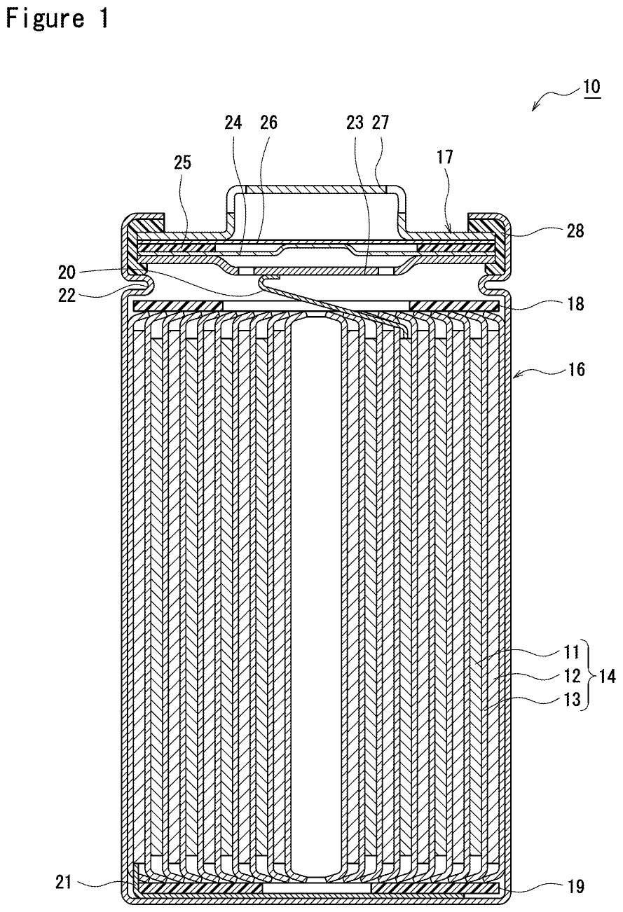

FIG. 1 is a diagram schematically showing a cross section of a non-aqueous electrolyte secondary battery 10 according to an embodiment of the present disclosure. As shown in FIG. 1, the non-aqueous electrolyte secondary battery 10 includes an electrode assembly 14 of a wound type, a non-aqueous electrolyte, and an outer housing can 16 which houses the electrode assembly 14 and the non-aqueous electrolyte. The electrode assembly 14 includes a positive electrode 11, a negative electrode 12, and a separator 13, and has a wound structure in which the positive electrode 11 and the negative electrode 12 are wound in a spiral shape with a separator 13 therebetween. The outer housing can 16 is a metal container having a circular cylindrical shape with a bottom, and opened on one side in an axial direction, and the opening of the outer housing can 16 is blocked by a sealing assembly 17. In the following, for convenience of description, a side of the sealing assembly 17 will be referred to as an “upper side”, and a side of a bottom of the outer housing can 16 will be referred to as a “lower side”.

The non-aqueous electrolyte includes a non-aqueous solvent and an electrolyte salt dissolved in the non-aqueous solvent. For the non-aqueous solvent, for example, esters, ethers, nitriles, amides, or a mixture solvent of two or more of these solvents may be employed. The non-aqueous solvent may include a halogen-substituted product in which at least a part of hydrogens of the solvent described above is substituted with a halogen element such as fluorine. Examples of the non-aqueous solvent include ethylene carbonate (EC), ethylmethyl carbonate (EMC), dimethyl carbonate (DMC), and a mixture solvent of these solvents. For the electrolyte salt, for example, a lithium salt such as LiPF₆ is used.

Each of the positive electrode 11, the negative electrode 12, and the separator 13 forming the electrode assembly 14 is an elongated member of a band shape, and these elements are alternately layered in a radial direction of the electrode assembly 14 by being wound in the spiral shape. The negative electrode 12 is formed in a slightly larger size than the positive electrode 11 in order to prevent precipitation of lithium. That is, the negative electrode 12 is formed longer in a longitudinal direction and a width direction (short-side direction) than the positive electrode 11. The separator 13 is formed in a slightly larger size at least than the positive electrode 11, and two separators 13 are placed sandwiching the positive electrode 11. The electrode assembly 14 has a positive electrode lead 20 connected to the positive electrode 11 through welding or the like, and a negative electrode lead 21 connected to the negative electrode 12 through welding or the like.

Insulating plates 18 and 19 are placed respectively above and below the electrode assembly 14. In the example configuration illustrated in FIG. 1, the positive electrode lead 20 extends through a through hole of the insulating plate 18 to the side of the sealing assembly 17, and the negative electrode lead 21 extends through an outer side of the insulating plate 19 to the side of the bottom of the outer housing can 16. The positive electrode lead 20 is connected to a lower surface of an internal terminal plate 23 of the sealing assembly 17 through welding or the like, and a cap 27 which is a top plate of the sealing assembly 17 electrically connected to the internal terminal plate 23 serves as a positive electrode terminal. The negative electrode lead 21 is connected to an inner surface of the bottom of the outer housing can 16 through welding or the like, and the outer housing can 16 serves as a negative electrode terminal.

As described above, the outer housing can 16 is a metal container having a circular cylindrical shape with a bottom, opened on one side in the axial direction. A gasket 28 is provided between the outer housing can 16 and the sealing assembly 17, so as to secure airtightness of the inside of the battery, and insulation between the outer housing can 16 and the sealing assembly 17. The outer housing can 16 has a grooved portion 22 in which a part of a side surface portion protrudes toward the inner side, and which supports the sealing assembly 17. The grooved portion 22 is desirably formed in an annular shape along a circumferential direction of the outer housing can 16, and supports the sealing assembly 17 with the upper surface thereof. The sealing assembly 17 is fixed at an upper part of the outer housing can 16 by the grooved portion 22 and an opening end of the outer housing can 16 crimped with respect to the sealing assembly 17.

The sealing assembly 17 has the internal terminal plate 23, a lower vent member 24, an insulating member 25, an upper vent member 26, and the cap 27, which are layered in this order from the side of the electrode assembly 14. The members of the sealing assembly 17 have, for example, a circular disk shape or a ring shape, and members other than the insulating member 25 are electrically connected to each other. The lower vent member 24 and the upper vent member 26 are connected to each other at respective center parts, and the insulating member 25 interposes between peripheral parts of the vent members. When abnormality occurs in the battery and an internal pressure of the battery increases, the lower vent member 24 deforms to push the upper vent member 26 toward the cap 27 and ruptures, and a current path between the lower vent member 24 and the upper vent member 26 is shut out. When the internal pressure further increases, the upper vent member 26 ruptures, and gas is discharged from an opening of the cap 27.

The positive electrode 11, the negative electrode 12, and the separator 13 forming the non-aqueous electrolyte secondary battery 10 will now be described in detail. In particular, the positive electrode 11 will be described in detail.

### [Electrode Structure]

An electrode according to an embodiment of the present disclosure includes a core and a mixture layer formed over the core. The mixture layer includes a first layer formed over the core, and a second layer and a third layer formed over the first layer. Each of the first layer, the second layer, and the third layer includes a binder. The third layer is formed over at least a part of an end portion of the electrode. A content of the binder in the third layer is greater than a content of the binder in the first layer, and a content of the binder in the second layer is lower than or equal to the content of the binder in the first layer. The third layer is formed over at least a part of an end portion of the first layer. According to such an electrode structure, superior cycle characteristic can be realized while suppressing the missing part of the mixture layer. The content of the binder is calculated as a ratio of a mass of the binder with respect to a mass of the mixture layer.

The electrode structure described above may also be applied to the negative electrode 12, but application of the electrode structure for the positive electrode 11 is particularly effective. In the following, a configuration will be described in which the mixture layer of the positive electrode 11 has the above-described structure. Alternatively, the above-described structure may be applied to both the positive electrode 11 and the negative electrode 12.

### [Positive Electrode]

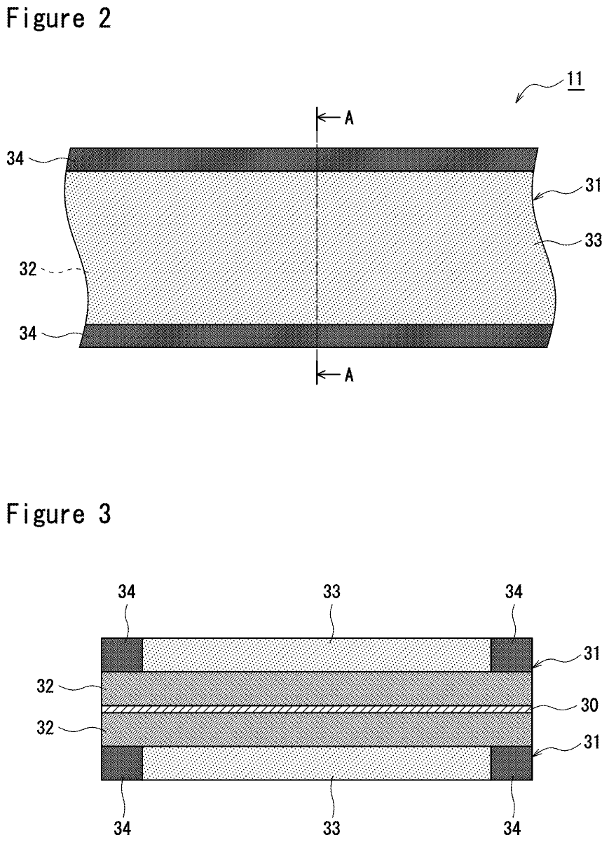

FIG. 2 is plan view showing a part of the positive electrode 11, and FIG. 3 is a cross sectional diagram along a line AA of FIG. 2. As shown in FIGS. 2 and 3, the positive electrode 11 includes a positive electrode core 30 and a positive electrode mixture layer 31 formed over the positive electrode core 30. As describe above, the positive electrode 11 is an elongated element formed in a band shape, and has a certain width along a longitudinal direction. For the positive electrode core 30, there may be employed a foil of a metal which is stable within a potential range of the positive electrode 11 such as aluminum and an aluminum alloy, a film on a surface layer of which the metal is placed, or the like. The positive electrode mixture layer 31 includes a positive electrode active material, a conductive agent, and a binder, and is desirably provided over both surfaces of the positive electrode core 30 other than a core exposed portion which is a portion to which the positive electrode lead is connected. A thickness of the positive electrode mixture layer 31 is, for example, 50 μm 150 μm on one side of the positive electrode core.

The positive electrode active material is formed with a lithium-transition metal composite oxide as a primary component. As elements contained in the lithium-transition metal composite oxide other than Li, there may be exemplified Ni, Co, Mn, Al, B, Mg, Ti, V, Cr, Fe, Cu, Zn, Ga, Sr, Zr, Nb, In, Sn, Ta, W, Si, and P. A desirable example of the lithium-transition metal composite oxide is a composite oxide containing at least one of Ni, Co, and Mn. As a specific example, there may be exemplified a lithium-transition metal composite oxide containing Ni, Co, and Mn, and a lithium-transition metal composite oxide containing Ni, Co, and Al.

As the conductive agent included in the positive electrode mixture layer 31, there may be exemplified carbon materials such as carbon black, acetylene black, Ketjenblack, graphite, or the like. As the binder included in the positive electrode mixture layer 31, there may be exemplified a fluororesin such as polytetrafluoroethylene (PTFE), polyvinylidene fluoride (PVDF), or the like, polyacrylonitrile (PAN), polyimide, an acrylic resin, polyolefin, or the like. Alternatively, these materials may be used in combination with a cellulose derivative such as carboxymethyl cellulose (CMC) or a salt thereof, polyethylene oxide (PEO), or the like.

The positive electrode mixture layer 31 has a plurality of layers having different contents of the binder, including a first layer 32 formed over the positive electrode core 30, and a second layer 33 and a third layer 34 formed over the first layer 32. While all of the first layer 32, the second layer 33, and the third layer 34 includes the positive electrode active material, the conductive agent, and the binder, the third layer 34 has the highest content of the binder. The contents of the binder in the first layer 32 and the second layer 33 may be the same, but desirably, the content of the binder is the lowest in the second layer 33. Thus, the content of the binder is ((second layer 33) (first layer 32)<(third layer 34)), and is desirably ((second layer 33)<(first layer 32)<(third layer 34)).

The first layer 32 is a lower layer of the positive electrode mixture layer 31, formed directly over a surface of the positive electrode core 30, and is formed, for example, over an entire region of the surface of the positive electrode core 30 except for the core exposed portion to which the positive electrode lead is connected. The second layer 33 and the third layer 34 are upper layers formed over the first layer 32. Desirably, the second layer 33 and the third layer 34 are formed to substantially not overlap each other. In the present embodiment, the second layer 33 and the third layer 34 are formed in a stripe shape along a longitudinal direction of the positive electrode 11, and form an outermost surface of the positive electrode mixture layer 31. In the positive electrode 11, other layers such as a protective layer covering the surface of the positive electrode mixture layer 31 may be formed within a range of not adversely affecting the advantages of the present disclosure.

The second layer 33 is formed at a center part in the width direction of the positive electrode 11. The second layer 33 is formed wider than the third layer 34, and widely covers the surface of the first layer 32. The third layer 34 is formed over at least a part of an end portion of the first layer 32. In the present embodiment, the third layer 34 is formed at respective ends in the width direction, along the longitudinal direction of the positive electrode 11.

As described above, the upper layer of the positive electrode mixture layer 31 is formed in a stripe pattern in which the second layer 33 is sandwiched by the third layers 34 positioned at respective ends in the width direction of the positive electrode 11. By placing the third layer 34 having a high content of the binder at respective ends in the width direction of the positive electrode 11, the missing part of the positive electrode mixture layer 31 during the manufacturing process of the positive electrode 11 or the like can be effectively suppressed. The suppression advantage of the missing part of the positive electrode mixture layer 31 can be realized when the third layer 34 is formed over at least a part of the end portion of the positive electrode 11. On the other hand, when the third layer 34 is present at the end portion of the positive electrode 11, the third layer 34 would block the return of the electrolyte solution squeezed out from the inside of the electrode assembly 14 due to the charging and discharging, but because the first layer 32 having a lower content of the binder than the third layer 34 exists at the end portion of the positive electrode 11, such a disadvantage can be resolved. That is, the first layer 32 becomes a passage of the electrolyte solution, and smooth return of the electrolyte solution can be enabled.

The third layer 34 is formed in a predetermined width from respective ends in the width direction of the first layer 32. No particular limitation is imposed on a width of the third layer 34, but the width is desirably greater than or equal to 1 mm and less than or equal to 8 mm, and is more desirably greater than or equal to 2 mm and less than or equal to 6 mm. When the width of the third layer 34 is within these ranges, the suppression advantage of the missing part of the positive electrode mixture layer 31 and the improvement advantage of the cycle characteristic are more significant. A width of the second layer 33 is greater than the width of the third layer 34, and is, for example, greater than or equal to 50 mm and less than or equal to 60 mm. The third layers 34 formed on respective ends in the width direction of the first layer 32 are desirably formed with substantially the same width. The first layer 32 is formed over the entire width of the positive electrode core 30, and a width obtained by adding the width of the second layer 33 and the width of the third layer 34 is the width of the first layer 32.

The content of the binder in the third layer 34 is higher than the contents of the binder in the first layer 32 and the second layer 33, and is greater than 0.8 mass % and lower than 2.0 mass %. When the content of the binder in the third layer 34 is lower than or equal to 0.8 mass %, the missing part of the mixture layer tends to easily occur on the end portion of the positive electrode mixture layer 31, in particular, at the cutting portion. On the other hand, when the content of the binder exceeds 2.0 mass %, the reduction in the capacity due to the charging and discharging becomes larger. The content of the binder in the third layer 34 is more desirably greater than or equal to 0.9 mass % and less than or equal to 1.8 mass %, and is particularly desirably greater than or equal to 1.0 mass % and less than or equal to 1.5 mass %. In this case, the suppression advantage of the missing part of the positive electrode mixture layer 31 and the improvement advantage of the cycle characteristic become more significant.

As described above, the content of the binder in the second layer 33 is lower than or equal to the content of the binder in the first layer 32, and is desirably lower than the content of the binder in the first layer 32. The content of the binder in the first layer 32 is desirably greater than or equal to 0.5 mass % and less than or equal to 1.0 mass %, and the content of the binder in the second layer 33 is desirably greater than or equal to 0.4 mass % and less than or equal to 0.8 mass %. Because the second layer 33 is formed in a large area over the first layer 32, by reducing the content of the binder in the second layer 33, it becomes possible to improve the permeability of the electrolyte solution from the surface of the positive electrode mixture layer 32, and to achieve more significant improvement advantage of the cycle characteristic.

The contents of the binder in the respective layers may be adjusted, for example, by adding the positive electrode active material and the binder while holding the content of the conductive agent constant. An example content of the conductive agent in respective layers is greater than or equal to 0.5 mass % and less than or equal to 1.5 mass %.

A ratio (T) between thicknesses of the second layer 33 and the third layer 34 and a thickness of the first layer 32 is, for example, 20:80 to 80:20, and is desirably 30:70 to 70:30. The thicknesses of the second layer 33 and the third layer 34 are substantially equal to each other. Thus, the ratio (T) may also be described as a ratio between a thickness of the upper layer and a thickness of the lower layer of the positive electrode mixture layer 31. When the ratio of the upper layer to the lower layer of the positive electrode mixture layer 31 is within the ranges described above, the suppression advantage of the missing part of the positive electrode mixture layer 31 and the improvement advantage of the cycle characteristic can be made more significant. Alternatively, the thicknesses of the upper layer and the lower layer may be substantially equal to each other.

The positive electrode 11 can be produced by applying a positive electrode mixture slurry including the positive electrode active material, the conductive agent, the binder, or the like over the surface of the core of an elongated shape with a wide width, drying the applied film, compressing and the dried film, to form the positive electrode mixture layer 31 over both surfaces of the elongated-shape core, and then cutting in a predetermined size. For the positive electrode mixture slurry, two types of slurries having different contents of the binder in the solid content are employed. The core of the elongated shape with the wide width is to be formed into the positive electrode core 30 by being cut, and has a width corresponding to widths of a plurality of positive electrodes 11. After the positive electrode mixture layer 31 corresponding to a plurality of positive electrode 11 is formed over both surfaces of the elongated-shape core, the elongated-shape core is cut along the longitudinal direction at the center part in the width direction of the third layer 34, and in the predetermined length, to obtain the positive electrode 11 having the above-described structure.

[Negative Electrode]

The negative electrode 12 includes a negative electrode core, and a negative electrode mixture layer formed over a surface of the negative electrode core. The negative electrode 12 is an elongated member of a band shape, and is formed in a wider width than the positive electrode 11. For the negative electrode core, there may be employed a foil of metal stable within a potential range of the negative electrode 12 such as copper, a film on a surface layer of which the metal is placed, or the like. The negative electrode mixture layer includes a negative electrode active material and a binder, and is desirably provided over both surfaces of the negative electrode core. The negative electrode 12 can be produced by, for example, applying a negative electrode mixture shiny including the negative electrode active material, a binder, or the like over the surface of the negative electrode core, drying the applied film, and compressing, to form the negative electrode mixture layer over both surfaces of the negative electrode core. The negative electrode mixture layer may include a conductive agent similar to those in the case of the positive electrode 11.

The negative electrode mixture layer includes, as the negative electrode active material, for example, a carbon material which reversibly occludes and releases lithium ions. Desirable examples of the carbon material include graphites such as natural graphites such as flake graphite, massive graphite, amorphous graphite, or the like, and artificial graphites such as massive artificial graphite (MAG), graphitized meso-phase carbon microbeads (MCMB), or the like. Alternatively, as the negative electrode active material, an active material may be employed which includes at least one of an element which forms an alloy with Li such as Si and Sn, and a compound containing the element. Desirable examples of the active material include a silicon material in which Si microparticles are dispersed in a silicon oxide phase or a silicate phase such as lithium silicate. For the negative electrode active material, for example, the carbon material such as graphite and the silicon material are used in combination.

For the binder contained in the negative electrode mixture layer, similar to the case of the positive electrode 11, the fluororesin, PAN, polyimide, the acrylic resin, polyolefin, or the like may be used, but desirably, styrene-butadiene rubber (SBR) is used. In addition, the negative electrode mixture layer desirably further includes CMC or a salt thereof, polyacrylic acid (PAA) or a salt thereof, polyvinyl alcohol (PVA), or the like. In particular, desirably, SBR, CMC or a salt thereof, and PAA or a salt thereof are used in combination.

### [Separator]

For the separator 13, a porous sheet having an ion permeability and an insulating property is employed. Specific examples of the porous sheet include a microporous thin film, a woven fabric, a non-woven fabric, or the like. As a material of the separator 13, there may be exemplified polyethylene, polypropylene, polyolefin such as a copolymer of ethylene and α-olefin, cellulose, polystyrene, polyester, polyphenylene sulfide, polyether ether ketone, a fluororesin, and the like. The separator 13 may have a single-layer structure or a layered structure. Alternatively, on a surface of the separator 13, a heat resistive layer including inorganic particles, or a heat resistive layer formed from a resin having a high heat endurance such as an aramid resin, polyimide, polyamide imide, or the like, may be formed.

### EXAMPLES

The present disclosure will now be described in further detail with reference to Examples. The present disclosure, however, is not limited to the Examples.

### Example 1

### [Preparation of Positive Electrode Mixture Slurry]

Lithium cobaltate, acetylene black, and polyvinylidene fluoride were mixed with a mass ratio of 98.2:1:0.8, and a suitable amount of N-methyl-2-pyrrolidone was added, to prepare a positive electrode mixture slurry A. Lithium cobaltate, acetylene black, and polyvinylidene fluoride were mixed with a mass ratio of 98:1:1, and a suitable amount of N-methyl-2-pyrrolidone was added, to prepare a positive electrode mixture slurry B.

### [Production of Positive Electrode]

The positive electrode mixture slurry A was applied over one surface of a positive electrode core of a band shape formed from an aluminum foil, and the applied film was dried. Then, over this applied film, the positive electrode mixture slurry A was applied with a width of 56 mm and the positive electrode mixture slurry B was applied with a width of 4 mm, respectively along a longitudinal direction of the positive electrode core, and the applied films were dried. With these processes, an applied film of a two-layer structure was formed, which includes a lower layer formed from the applied film of the positive electrode mixture slurry A and an upper layer formed from the applied films of the positive electrode mixture slurries A and B. In this process, amounts of application of the mixture slurries were adjusted such that a ratio of a thickness of the upper layer to a thickness of the lower layer is 50:50. An applied film of the two-layer structure was also formed through a similar method over the other surface of the positive electrode core. The applied films were compressed using a roller such that a total thickness of the applied films was 160 μm, and the positive electrode core over which the applied films were formed was cut in a predetermined size, to produce a positive electrode in which the positive electrode mixture layer was formed over both surfaces of the positive electrode core.

A first layer of the mixture layer was formed by the positive electrode mixture slurry A applied directly over the surface of the positive electrode core, a second layer of the mixture layer was formed by the positive electrode mixture slurry A applied over the first layer, and a third layer of the mixture layer was formed by the positive electrode mixture slurry B applied over the first layer. Contents of the binder in the first layer, the second layer, and the third layer were respectively 0.8 mass %, 0.8 mass %, and 1.0 mass %. The core over both surfaces of which the mixture layer was formed was cut at a center part in the width direction of the third layer along the longitudinal direction. With this process, a positive electrode was obtained in which the third layer having a width of 2 mm was formed along the longitudinal direction of the positive electrode, at each of the end portions in the width direction.

[Production of Negative Electrode]

Graphite, a sodium salt of carboxymethyl cellulose, and a dispersion of a copolymer of styrene-butadiene were mixed with a solid content mass ratio of 98:1:1, and a suitable amount of water was added, to prepare a negative electrode mixture slurry. The negative electrode mixture slurry was applied over a negative electrode core of a band shape formed from a copper foil, the applied film was dried, the dried film was then compressed using a roller, and the negative electrode core was cut in a predetermined size, to produce a negative electrode in which a negative electrode mixture layer was formed over both surfaces of the negative electrode core.

### [Preparation of Non-Aqueous Electrolyte Solution]

Ethylene carbonate and diethyl carbonate were mixed in a volume ratio of 1:1, and then, fluoroethylene carbonate was added in a concentration of 2 mass %. LiPF₆ was added to the mixture solvent in a concentration of 1 mol/L, to obtain a non-aqueous electrolyte solution.

### [Production of Non-Aqueous Electrolyte Secondary Battery]

The positive electrode to which an aluminum lead is welded and the negative electrode to which a nickel lead is welded were wound in a spiral shape with a separator (a composite porous film of polyethylene and polypropylene, having a thickness of 20 μm) therebetween, to produce an electrode assembly of a wound type. The electrode assembly was housed in an outer housing can of a circular cylindrical shape with a bottom, having a diameter of 18 mm and a height of 65 mm, 5.2 mL of the non-aqueous electrolyte solution was injected into the outer housing can, and an opening of the outer housing can was sealed with a sealing assembly via a gasket, to obtain a test cell (non-aqueous electrolyte secondary battery).

### [Assessment of Missing Part of Positive Electrode Mixture Layer]

The end portions in the width direction of the positive electrode were observed with human eyes, and presence or absence of a missing part of the positive electrode mixture layer was checked.

[Assessment of Cycle Characteristic]

Under a temperature condition of 25° C., the produced test cell was charged with a constant current of 0.7 lt until a battery voltage reached 4.2 V, and was then charged with a constant voltage of 4.2 V until the current reached 0.05 It. Then the test cell was discharged with a constant current of 0.7 lt until the battery voltage reached 2.5 V. This charging/discharging cycle was performed for 100 cycles, and a capacity maintenance rate was determined based on the following formula. Table 1 shows the result of the assessment (similarly applicable to Examples and Comparative Examples described below). The assessment result shown in Table 1 is a relative value, with the capacity maintenance rate of the test cell of Comparative Example 1 being 100.

Capacity maintenance rate (%)=(discharge capacity at 100th cycle/discharge capacity at 1st cycle)×100

### Example 2

Lithium cobaltate, acetylene black, and polyvinylidene fluoride were mixed with a mass ratio of 98.4:1:0.6, and a suitable amount of N-methyl-2-pyrrolidone was added, to produce a positive electrode mixture slurry C. A positive electrode and a test cell were produced in a manner similar to Example 1 except that the positive electrode mixture slurry C was used as the positive electrode mixture slurry for forming the second layer.

### Example 3

Lithium cobaltate, acetylene black, and polyvinylidene fluoride were mixed with a mass ratio of 97.5:1:1.5, and a suitable amount of N-methyl-2-pyrrolidone was added, to produce a positive electrode mixture slurry D. A positive electrode and a test cell were produced in a manner similar to Example 1 except that the positive electrode mixture slurry B was used as the positive electrode mixture slurry for forming the first layer, and the positive electrode mixture slurry D was used as the positive electrode mixture slurry for forming the third layer.

### Example 4

A positive electrode and a test cell were produced in a manner similar to Example 2 except that the ratio of the thickness of the upper layer to the thickness of the lower layer was set to 20:80.

### Example 5

A positive electrode and a test cell were produced in a manner similar to Example 2 except that the ratio of the thickness of the upper layer to the thickness of the lower layer was set to 30:70.

### Example 6

A positive electrode and a test cell were produced in a manner similar to Example 2 except that the ratio of the thickness of the upper layer to the thickness of the lower layer was set to 70:30.

### Example 7

A positive electrode and a test cell were produced in a manner similar to Example 2 except that the ratio of the thickness of the upper layer to the thickness of the lower layer was set to 80:20.

### Example 8

A positive electrode and a test cell were produced in a manner similar to Example 2 except that the width of the third layer formed at each of the end portions in the width direction of the positive electrode was set to 6 mm.

### Example 9

A positive electrode and a test cell were produced in a manner similar to Example 2 except that the width of the third layer formed at each of the end portions in the width direction of the positive electrode was set to 8 mm.

### Comparative Example 1

A positive electrode and a test cell were produced in a manner similar to Example 1 except that the positive electrode mixture slurry B was used as the slurry for forming the first layer and the second layer.

### Comparative Example 2

A positive electrode and a test cell were produced in a manner similar to Example 1 except that the positive electrode mixture slurry B was used as the slurry for forming the second layer.

### Comparative Example 3

Acetylene black and polyvinylidene fluoride were mixed with a mass ratio of 98.5:1:0.5, and a suitable amount of N-methyl-2-pyrrolidone was added, to produce a positive electrode mixture slurry E. A positive electrode and a test cell were produced in a manner similar to Example 1 except that the positive electrode mixture slurry C was used as the slurry for forming the first layer, and the positive electrode mixture slurry E was used as the slurry for forming the second layer.

### Comparative Example 4

Lithium cobaltate, acetylene black, and polyvinylidene fluoride were mixed with a mass ratio of 97:1:2, and a suitable amount of N-methyl-2-pyrolidone was added, to produce a positive electrode mixture slurry F. A positive electrode and a test cell were produced in a manner similar to Example 3 except that the positive electrode mixture slurry F was used as the slurry for forming the third layer.

TABLE 1

| | POSITIVE ELECTRODE MIXTURE LAYER | | | | | ASSESSMENT RESULT | |
|---|---|---|---|---|---|---|---|
| | | | | UPPER LAYER/ | | MISSING | |
| | BINDER CONTENT (MASS %) | | | LOWER LAYER | WIDTH OF | PART OF | CAPACITY |
| | FIRST | SECOND | THIRD | THICKNESS | THIRD | MIXTURE | MAINTENANCE |
| | LAYER | LAYER | LAYER | RATIO | LAYER | LAYER | RATE |
| COMPARATIVE | 1.0 | 1.0 | 1.0 | 50/50 | 2 | NONE | 100 |
| EXAMPLE 1 | | | | | | | |
| COMPARATIVE | 0.8 | 1.0 | 1.0 | 50/50 | 2 | NONE | 100.5 |
| EXAMPLE 2 | | | | | | | |
| COMPARATIVE | 0.6 | 0.5 | 0.8 | 50/50 | 2 | OBSERVED | 105.0 |
| EXAMPLE 3 | | | | | | | |
| COMPARATIVE | 1.0 | 0.8 | 2.0 | 50/50 | 2 | NONE | 95.2 |
| EXAMPLE 4 | | | | | | | |
| EXAMPLE 1 | 0.8 | 0.8 | 1.0 | 50/50 | | NONE | 104.4 |
| EXAMPLE 2 | 0.8 | 0.6 | 1.0 | 50/50 | 2 | NONE | 106.2 |
| EXAMPLE 3 | 1.0 | 0.8 | 1.5 | 50/50 | 2 | NONE | 103.5 |
| EXAMPLE 4 | 0.8 | 0.6 | 1.0 | 20/80 | 2 | NONE | 102.2 |
| EXAMPLE 5 | 0,8 | 0.6 | 1.0 | 30/70 | 2 | NONE | 106.4 |
| EXAMPLE 6 | 0.8 | 0.6 | 1.0 | 70/30 | 2 | NONE | 106.8 |
| EXAMPLE 7 | 0.8 | 0.6 | 1.0 | 80/20 | 2 | NONE | 102.7 |
| EXAMPLE 8 | 0.8 | 0.6 | 1.0 | 50/50 | 6 | NONE | 105.7 |
| EXAMPLE 9 | 0.8 | 0.6 | 1.0 | 50/50 | 8 | NONE | 102.4 |

As shown in Table 1, the test cells of Examples had higher capacity maintenance rates after charge/discharge cycles and superior cycle characteristics in comparison to test cells of Comparative Examples 1, 2, and 4. It can be deduced that, in the test cells of Comparative Examples 1 and 4, because the content of the binder is too high at the end portions in the width direction of the positive electrode, the return of the electrolyte solution squeezed out from the inside of the electrode assembly due to the expansion of the negative electrode due to the charging and discharging was blocked, resulting in non-uniformity of the electrode reaction, and consequently, a greater reduction of the capacity. It can further be deduced that, in the test cell of Comparative Example 2, because the content of the binder is too high at the upper layer (second layer) of the positive electrode mixture layer, it became more difficult for the electrolyte solution to permeate into the positive electrode mixture layer, resulting in the non-uniformity of the electrode reaction, and consequently, a greater reduction of the capacity. In the contrary, it can be deduced that, in the test cells of Examples, the squeezed-out electrolyte solution can easily return to the inside of the electrode assembly and the electrolyte solution can easily permeate into the positive electrode mixture layer, resulting in suppression of the non-uniformity of the electrode reaction, and achievement of superior cycle characteristic.

Furthermore, in the test cell of Comparative Example 3, a missing part of the positive electrode mixture layer was observed, but no mixing part of the positive electrode mixture layer was observed for the test cells of Examples. It can be deduced that, in Comparative Example 3, an amount of binding of the mixture layer was insufficient at the end portions of the positive electrode, resulting in the occurrence of the missing part of the mixture layer. In the contrary, according to the test cells of Examples, superior cycle characteristic can be realized while suppressing the missing part of the positive electrode mixture layer. In particular, the improvement advantage of the cycle characteristic was more significant when the content of the binder in the second layer was lower than the content of the binder in the first layer, when the thickness ratio of the upper layer to the lower layer was 30:70 to 70:30, and when the width of the third layer was greater than or equal to 2 mm and less than or equal to 6 mm.

### REFERENCE SIGNS LIST

10 non-aqueous electrolyte secondary battery, 11 positive electrode, 12 negative electrode, 13 separator, 14 electrode assembly, 16 outer housing can, 17 sealing assembly, 18, 19 insulating plate, 20 positive electrode lead, 21 negative electrode lead, 22 grooved portion, 23 internal terminal plate, 24 lower vent member, 25 insulating member. 26 upper vent member, 27 cap, 28 gasket, 30 positive electrode core, 31 positive electrode mixture layer, 32 first layer, 33 second layer, 34 third layer

1. A non-aqueous electrolyte secondary battery comprising:
an electrode having a core and a mixture layer formed over the core; and
a non-aqueous electrolyte, wherein
the mixture layer includes a first layer formed over the core, and a second layer and a third layer formed over the first layer,
each of the first layer, the second layer, and the third layer includes a binder,
the third layer is formed over at least a part of an end portion of the electrode,
a content of the binder in the third layer is higher than a content of the binder in the first layer, and is greater than 0.8 mass % and lower than 2.0 mass %, and
a content of the binder in the second layer is lower than or equal to the content of the binder in the first layer.

2. The non-aqueous electrolyte secondary battery according to claim 1, wherein
the electrode is formed in a band shape, and
the third layer is formed along a longitudinal direction of the electrode, at respective end portions in a width direction.

3. The non-aqueous electrolyte secondary battery according to claim 2, wherein
a width of the third layer is greater than or equal to 2 mm and less than or equal to 6 mm.

4. The non-aqueous electrolyte secondary battery according to claim 1, wherein
the content of the binder in the third layer is greater than or equal to 1.0 mass % and less than or equal to 1.5 mass %.

5. The non-aqueous electrolyte secondary battery according to claim 1, wherein
the content of the binder in the second layer is lower than the content of the binder in the first layer.

6. The non-aqueous electrolyte secondary battery according to claim 1, wherein
a ratio of thicknesses of the second layer and the third layer to a thickness of the first layer is 30:70 to 70:30.
